(19) United States
(12) Patent Application Publication
(10) Pub. No.: US 2011/0174173 A1
(43) Pub. Date: Jul. 21, 2011

(54) SPLIT END RING FOR ROTARY PRINTING SCREEN AND METHOD

(75) Inventor: Paul J. Stelpflug, Concord, NC (US)

(73) Assignee: STORK PRINTS AMERICA, INC., Charlotte, NC (US)

(21) Appl. No.: 12/689,094

(22) Filed: Jan. 18, 2010

(51) Int. Cl. B05C 17/08

(52) U.S. Cl. 101/127.1

(57) ABSTRACT

An end ring assembly for attachment to a cylindrical rotary printing screen includes an annular support ring adapted to be attached to an interior wall of the cylindrical rotary printing screen, and a drive ring adapted to be releasably attached to the annular support ring in position registration with the support ring to maintain alignment therewith upon rotation of the drive. A method of cleaning and/or storing a cylindrical rotary printing screen includes providing a cylindrical rotary printing screen having two opposed ends, and providing an end ring assembly on each end of the screen. Each end ring assembly has an annular support ring attached to an interior wall of the cylindrical rotary printing screen and a drive ring releasably attached to the annular support ring in position registration with the support ring. The drive rings are removed from the respective support rings, so that printing screen can be cleaned and/or stored with the support rings still attached.

### TECHNICAL FIELD OF THE INVENTION

This invention relates to an end ring for a rotary printing screen, more particularly to a split end ring having a screen-supporting ring and a drive ring separable from the screen-supporting ring, and a method of cleaning and/or storing a cylindrical rotary printing screen.

### BACKGROUND OF THE INVENTION

Rotary screen printing entails use of a pattern-perforated or woven screen that is generally constructed of thin metal film layer. The metal film layer of the screen is typically so thin that the screen collapses or at least deforms under its own weight when laid along its longitudinal axis and is vulnerable to damage when handled such that cleaning of the screen is not typically feasible. The screen is typically mounted between end rings that have gears driven by a screen-printing machine. A number of the screens are driven in registration with each other and individually lay down an ink layer onto a substrate that collectively forms the desired image. The end rings typically have screen-facing ends that are glued into the longitudinal ends of the screen and opposing ends having gears, which are typically heavy and expensive to manufacture. A typical screen does exhibit some degree of rigidity once the end rings are mounted into the screen, but the screen is nonetheless subject to collapse during handling if the screen is used to support the heavy end rings. Thus, heavy geared end rings are particularly problematic with longer screens.

The screen is usually permanently attached to an end ring at each end of the screen. Removal of the screen from the end rings typically destroys the screen. Thus, the end rings can be salvaged for re-use, but the screen cannot be easily cleaned unsupported once it is unattached from the end rings even if the screen survives the removal intact. Even if a careful arrangement is made to store the screen with the heavy geared end rings attached, the expensive geared end rings are then unavailable for use with other printing jobs until they are ultimately recovered from the screen. Thus, if a mounted screen for a particular print job is to be taken from a printing machine and stored while other print jobs are completed, extra ones of the expensive geared end rings are required.

### BRIEF SUMMARY OF THE INVENTION

Therefore it is an object of the present invention to provide a split end ring having a support ring for attachment to a cylindrical rotary printing screen to support the screen and a drive ring releasably attachable to the support ring for rotating the screen when driven by a rotary screen printing machine. According to at least one embodiment of the invention, an end ring assembly for attachment to a cylindrical rotary printing screen includes an annular support ring adapted to be attached to an interior wall of the cylindrical rotary printing screen, and a drive ring adapted to be releasably attached to the annular support ring in position registration with the support ring to maintain alignment with the support ring during machine operation.

According to another embodiment of the invention, a method of cleaning and/or storing a cylindrical rotary printing screen includes the steps of providing a cylindrical rotary printing screen having two longitudinal ends, and providing an end ring assembly for each end of the screen. Each end ring assembly has an annular support ring attached to an interior wall of the cylindrical rotary printing screen and a drive ring releasably attached to the annular support ring in position registration with the support ring. When not in use, the drive rings can be removed from the support rings, and the printing screen cleaned and/or stored with the attached support rings.

### BRIEF DESCRIPTION OF THE DRAWINGS

The subject matter that is regarded as the invention may be best understood by reference to the following description taken in conjunction with the accompanying drawing figures in which:

FIG. 1 is an exploded perspective view of a split end ring for rotary screen printing according to one embodiment of the present invention;

FIG. 2 is a perspective view of the of split end ring of FIG. 1, shown assembled, and a cylindrical rotary printing screen;

FIG. 3 is a plan view of the screen-facing sides of the drive ring and support ring of FIG. 1;

FIG. 4 is a plan view of the screen-opposing sides of the drive ring and support ring of FIG. 1;

FIG. 5 is an elevation view of the drive ring of FIG. 1;

FIG. 6 is an elevation view of the support ring of FIG. 1;

FIG. 7 is a plan view of the screen-opposing side of the split end ring of FIG. 1, shown assembled.

FIG. 8 is an exploded perspective view of a split end ring for rotary screen printing according to another embodiment of the present invention, having a drive ring and a support ring;

FIG. 9 is a perspective view of the split end ring of FIG. 8, shown assembled; and

FIG. 10 is a plan view of the screen-opposing side of the split end ring of FIG. 8.

### DETAILED DESCRIPTION OF THE INVENTION

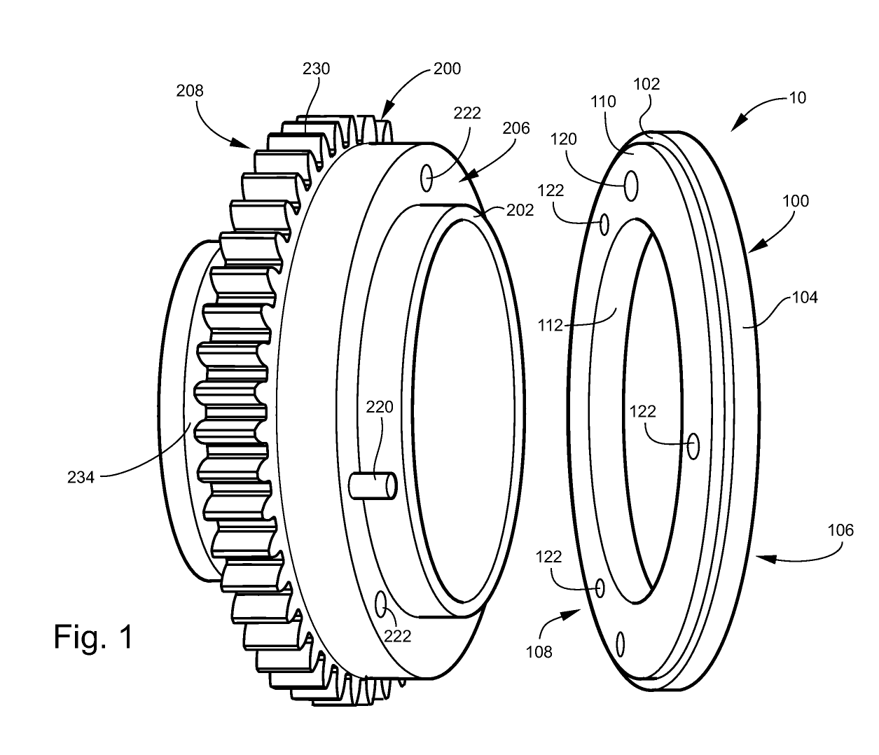

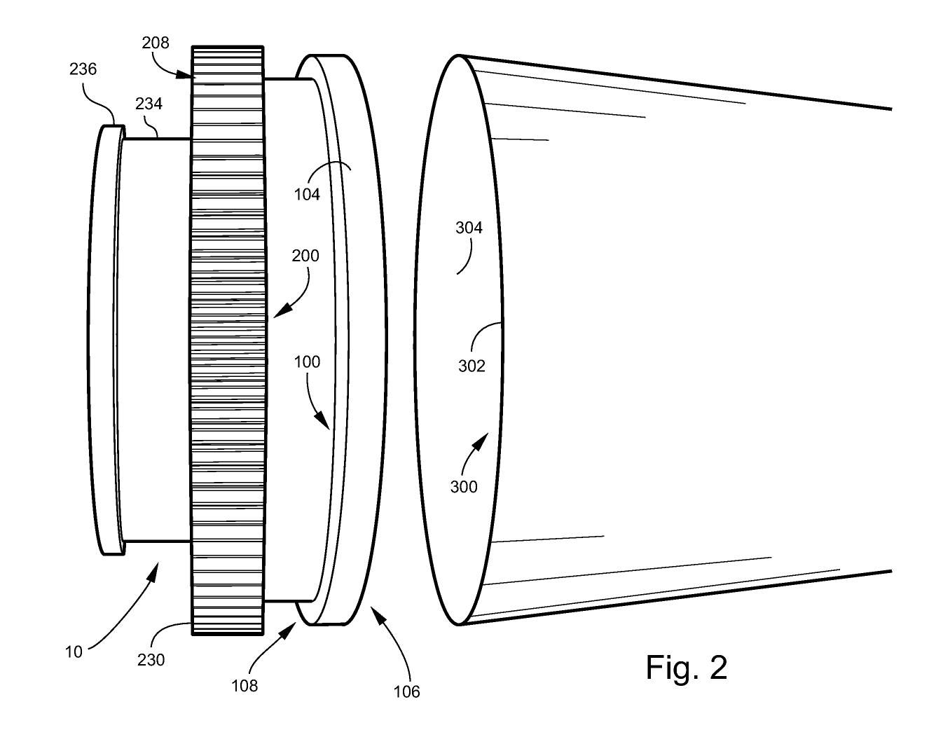

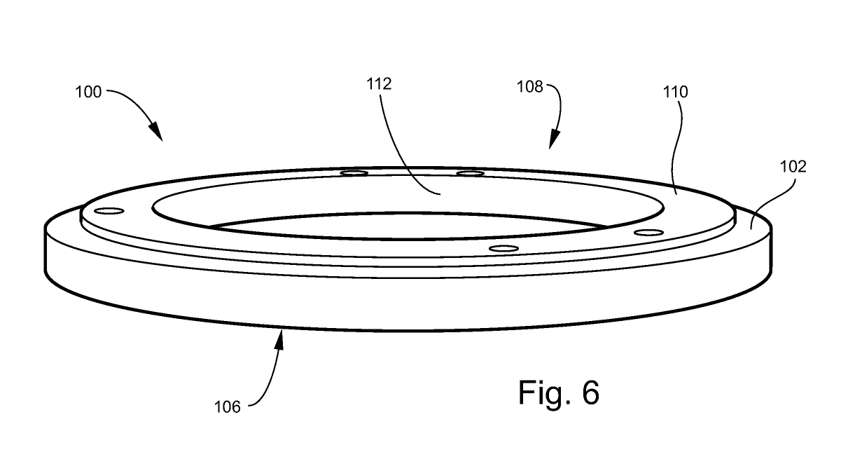

Referring now to the drawings, where identical reference numerals denote the same elements throughout the various views, FIG. 1 shows a split end ring 10 according to one embodiment of the present invention. The split end ring 10 includes a support ring 100 and a drive ring 200 that are two separate parts when the split end ring is disassembled as shown in FIG. 1. The support ring 100 has an annular body 102 having a cylindrical outer bearing surface 104 to which the interior wall 304 of a rotary printing screen 300 (FIG. 2) is to be attached by an adhesive at the longitudinal end 302 of the rotary printing screen 300. The support ring 100 has a screen-facing side 106 that faces into the screen 300 and a screen-opposing side 108 that faces outward toward the drive ring 200. As shown in FIG. 6, the support ring 100 has a raised annular shoulder 110 on the screen-opposing side 108 that abuts the drive ring 200 when the split end ring 100 is assembled as shown in FIG. 2. The support ring 100 has a cylindrical inner surface 112 that fits around a cylindrical extension 202 (FIG. 1) of the drive ring 200 upon assembly of the split end ring 100 as shown in FIG. 2.

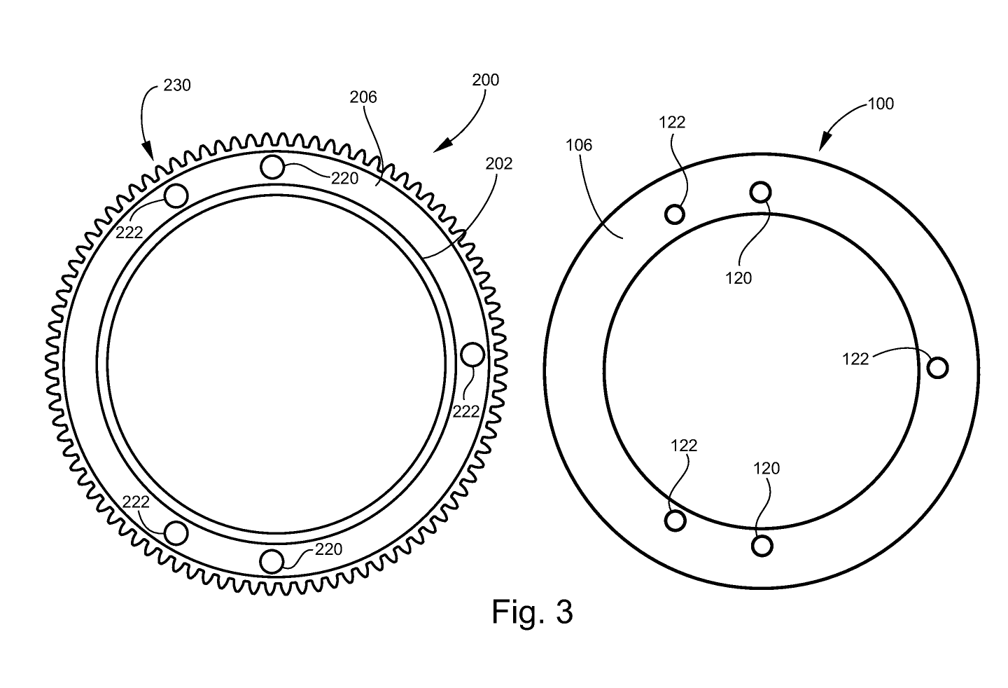

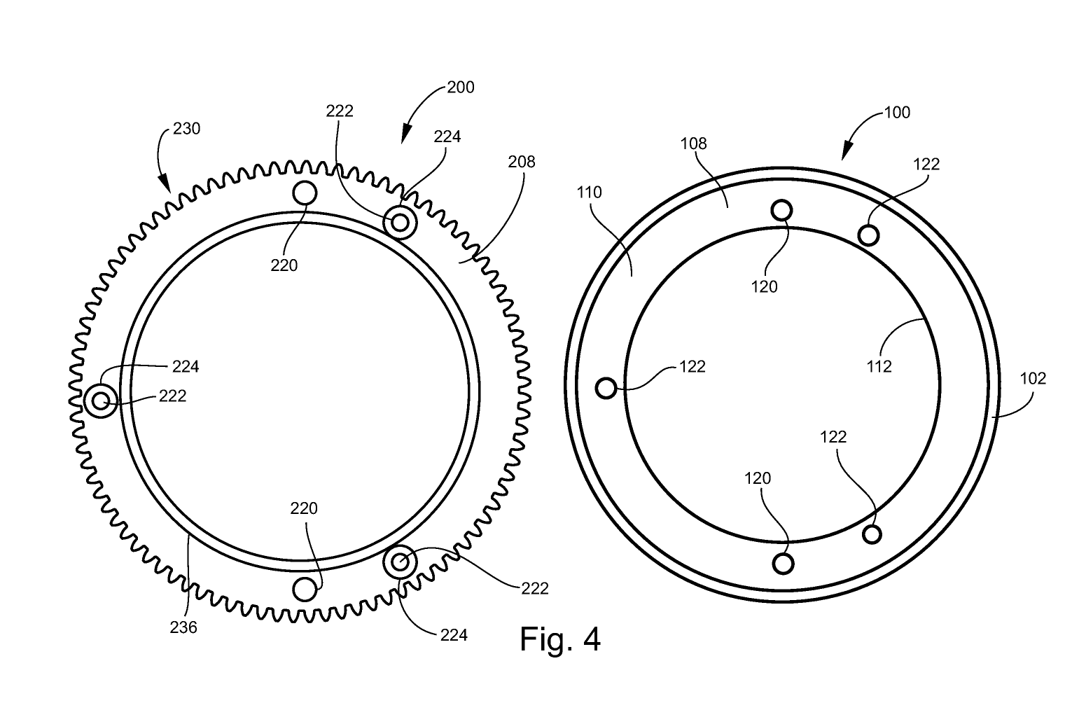

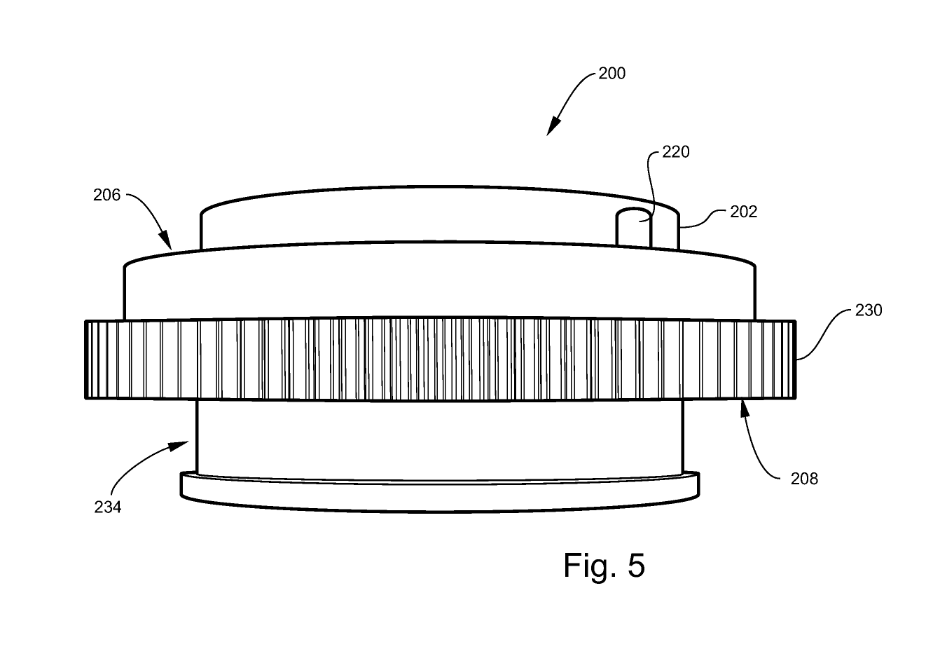

Like the support ring 100, the drive ring 200 has a screen-facing side 206 that faces toward the screen 300 and the support ring 100, and a screen-opposing side 208 that faces outward away from the screen 300 and support ring 100. The screen-facing sides 106 and 206 of the support ring 100 and drive ring 200 are shown in FIG. 3. The screen-opposing sides 108 and 208 of the support ring 100 and drive ring 200 are shown in FIG. 4. The cylindrical extension 202 of the drive ring 200 extends longitudinally from the screen-facing side 206 as shown for example in FIGS. 1, 3 and 5. Registration pins 220 extend from the screen-facing side 206 of the drive ring 200 to be received in corresponding registration holes 120 of the support ring 100 to assure a proper alignment arrangement between the drive ring 200 and support ring 100. The pins 220 are attached to the drive ring 200 by press fitting the pins into holes formed in the drive ring and are flush with the screen opposing side 208 of the drive ring.

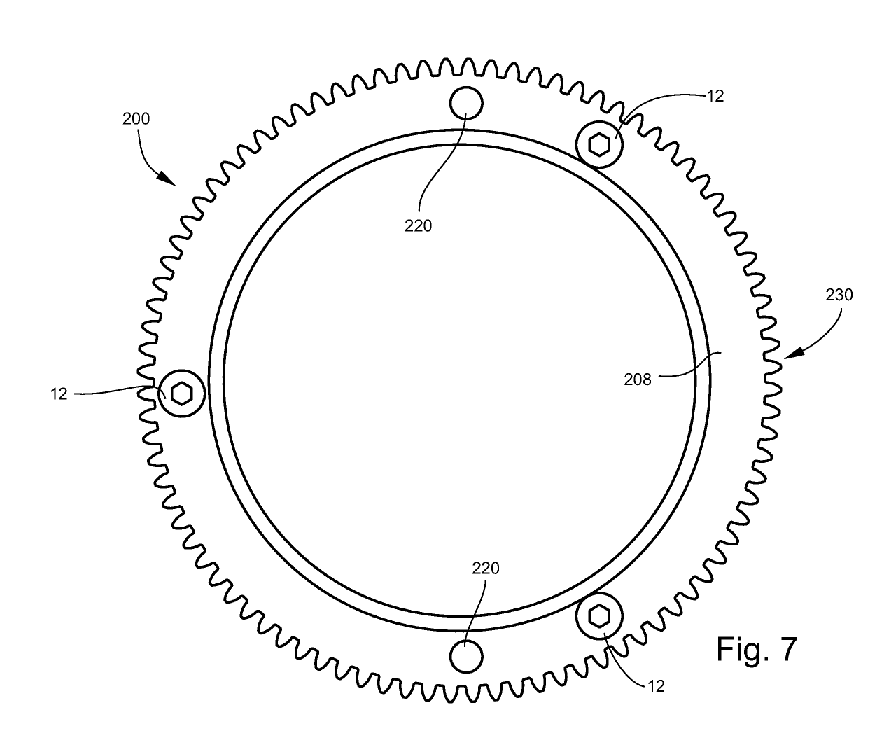

As shown in FIGS. 3 and 4, the drive ring 200 has multiple connector holes 222 and the support ring 100 has corresponding threaded connector holes 122 through which the drive ring 200 and support ring 100 are connected together by screws 12 as shown in FIG. 7 upon assembly of the drive ring 200 and support ring 100. As shown in FIG. 4, countersink spaces 224 are formed around the connector holes 222 in the screen-opposing side 208 of the drive ring 200 to receive the heads of the screws 12 flush with the surface of the screen-opposing side 208 of the drive ring 200.

To assemble the split end ring 100, the shoulder 110 of screen-opposing side 108 of the support ring 100 is abutted against the screen-facing side 206 of the drive ring 200, with the registration pins 220 of the drive ring 200 extending through the registration holes 120 of the support ring 100. Then the screws 12 are passed through the connector holes 222 of the drive ring 200, threaded into the connector holes 122 of the support ring 100, and tightened by turning the heads of the screws in a clockwise direction. Disassembly of the split end ring 100 is accomplished by these steps taken in reverse order.

While the Figures illustrated two registration pins 220 and two corresponding registration holes 120, the descriptions relate to more or less pins and holes as well. Similarly, while three connectors holes 122 and 222 are illustrated in each of the support ring 100 and drive ring 200, respectively, for accommodating three connecting screws, these descriptions relate to support rings and drive rings connected by more or less screws as well. For example, in at least one embodiment, the support ring and drive ring each have four connecting holes for accommodating four screws that connect the drive ring to the support ring.

The drive ring 200 has a spur gear 230 by which the entire assembly of the drive ring 200, support ring 100, and screen 300 are rotated when installed in a rotary printing machine and used in printing. The screen 300 in use will have an assembled end ring 10 attached to each longitudinal end 302 (FIG. 2). A cylindrical idler extension 234 extends longitudinally opposite the cylindrical extension 202 and outwardly from the screen-opposing side 208 of the drive ring 200 beyond the spur gear 230 to roll upon idler rollers or other supporting elements of the printing machine. A guide flange 236 extends radially outward from the longitudinal end of the idler extension 230 such that the idler extension, the guide flange 236 and the screen-opposing side 208 of the drive ring form a channel within which idler rollers or other supporting elements may support the rotating drive ring 200 when in use.

When a particular screen is not in use or is to be cleaned, the drive rings 200 at the longitudinal ends of the screen are removed from their respective support rings 100, which remain attached to the screen to support the screen in a rigid cylindrical shape as the screen is cleaned and/or stored. The drive rings 200 are then available for use with other screens thus reducing the need for inventories of expensive drive rings. The support rings 100 may be recovered once a screen is of no further use or may be discarded with the screen.

The support ring 100 is constructed of a suitably lightweight, relatively inexpensive material that is sufficiently rigid to support the screen in a cylindrical shape as the screen is cleaned and/or stored, and is yet relatively inexpensive to use in the manufacturing of the support ring. Aluminum and other metals may be selected for their durability against cleaning solvents like acetone where multiple reuse of the support ring is contemplated. Polyvinyl chloride (PVC) or other plastics such as nylon and delron may be selected for their relatively low costs where the support rings may be contemplated as expendable. Relatively large numbers of the support rings 100 can therefore be used without undue expense. The drive ring 200 is preferably constructed of a durable material, such as aluminum or other rigid material. The drive rings 200 may be removed from a screen and reused without also removing the support ring 100 from the screen, thus minimizing the quantity required and substantially reducing the expense of purchasing and inventorying the relatively expensive parts. The drive rings 200 can be removed easily from a screen mounted support ring 100 and attached to another support ring 100.

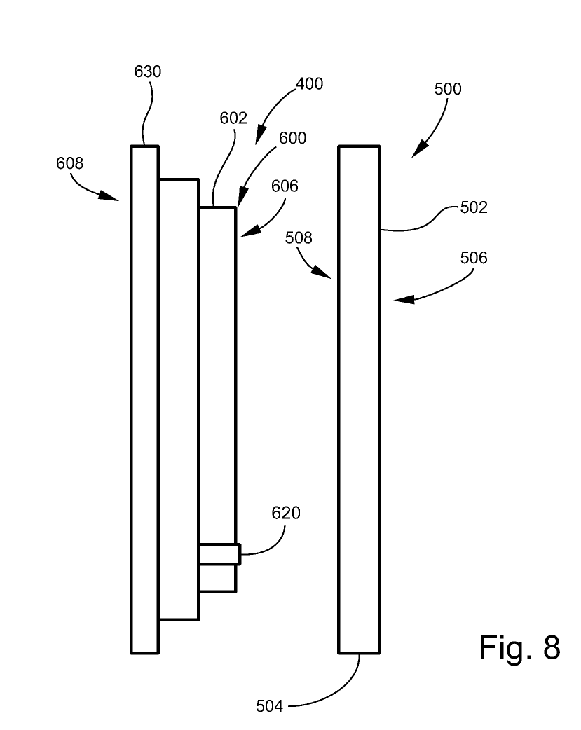

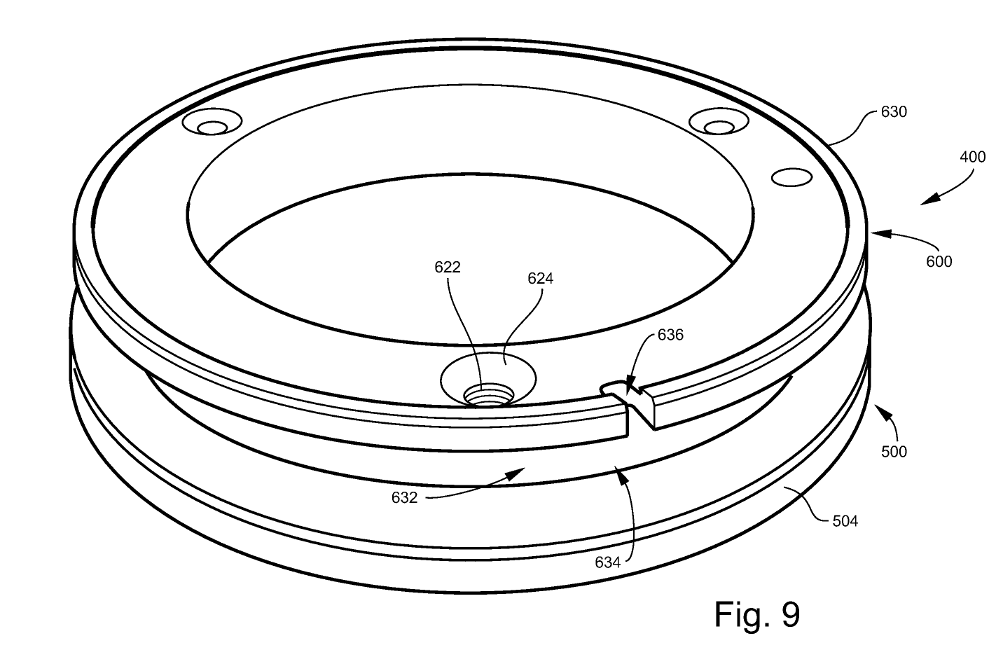

A split end ring 400 according to another embodiment of the invention is shown in FIGS. 8-10. The split end ring 400 includes a support ring 500 and a drive ring 600 that are two separate parts when the split end ring is disassembled as shown in FIG. 8. The support ring 500 has an annular body 502 having a cylindrical outer bearing surface 504 to which the interior wall of a rotary printing screen is to be attached by an adhesive at the longitudinal end of the rotary printing screen. The support ring 500 has a screen-facing side 506 that faces into the screen and a screen-opposing side 508 the faces outward toward the drive ring 600. The support ring 500 has a cylindrical inner surface (not shown) that fits around a cylindrical extension 602 of the drive ring 600 upon assembly of the split end ring 400 as shown in FIG. 9.

Like the support ring 500, the drive ring 600 has a screen-facing side 606 and a screen-opposing side 608 that faces outward away from the screen and support ring 500. The cylindrical extension 602 of the drive ring 600 extends from the screen-facing side 606 as shown in FIG. 8. As also shown in FIG. 8, registration pins 620 extends from the screen-facing side 606 of the drive ring 600 to be received in corresponding registration holes of the support ring 500 to assure a proper alignment arrangement between the drive ring 600 and support ring 500.

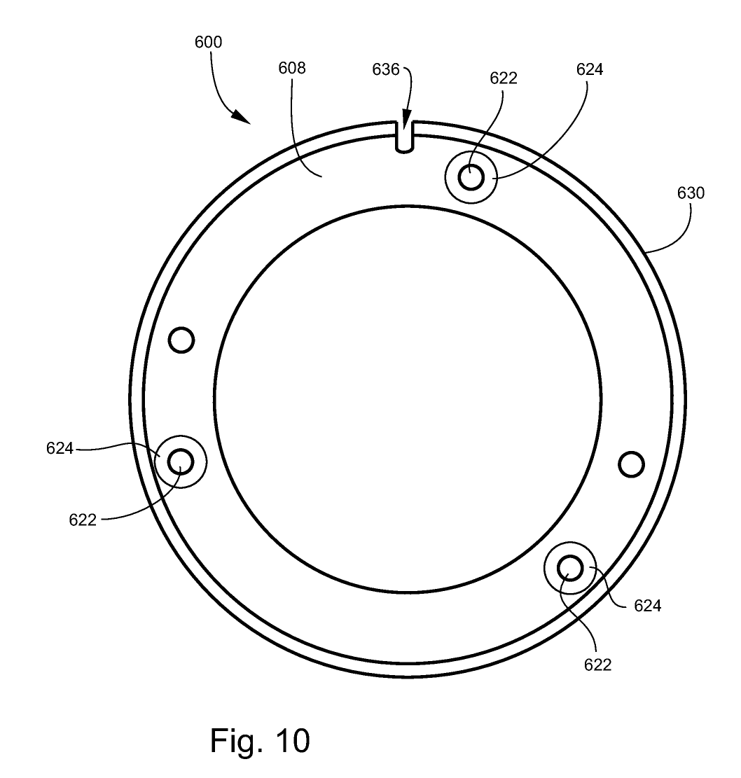

As shown in FIG. 10, the drive ring 600 has multiple connector holes 622 and the support ring 500 has corresponding connector holes (not shown) through which the drive ring 600 and support ring 500 are connected together by screws (not shown) upon assembly. Countersink holes 624 are formed around the connector holes 622 in the screen-opposing side 608 of the drive ring 600 to receive the heads of the screws flush with the surface of the screen-opposing side 608 of the drive ring 600.

To assemble the split end ring 400, the screen-opposing side 508 of the support ring 500 is abutted against the screen-facing side 606 of the drive ring 600, with the registration pins 620 of the drive ring 600 extending through the registration holes of the support ring 500. Then screws are passed through the connector holes 622 of the drive ring 600, threaded into the connector holes of the support ring 500, and tightened by turning the heads of the screws in a clockwise direction. Disassembly of the split end ring 400 is accomplished by these steps taken in reverse order.

The drive ring 600 has a flange 630 that extends radially outward at the screen-opposing side 608. An idler channel 632 (FIG. 9) is defined between the flange 630 and the support ring 500. Within the channel 632, an outer cylindrical surface 634 of the drive ring 600 rolls upon idler rollers or other supporting elements of the printing machine when the drive ring 600, support ring 500, and screen are installed in a rotary printing machine and used in printing. The flange 630 has a drive slot 636 (FIG. 10) by which the drive ring 600, support ring 500, and screen are rotated when in use.

A printing screen in use will have an assembled end ring 400 attached to each longitudinal end. When a particular screen is not in use or is to be cleaned, the drive rings 600 at the longitudinal ends of the screen are removed from their respective support rings 500, which remain attached to the screen to support the screen in a rigid cylindrical shape as the screen is cleaned and/or stored. The drive rings 600 are then available for use with other screens thus reducing the need for inventories of expensive drive rings. The support rings 500 may be recovered once a screen is of no further use or may be discarded with the screen.

The support ring 500 and drive ring 600 can be constructed of material as described above with reference to support ring 100 and drive ring 200.

The foregoing has described split end rings having releasably attachable support rings and drive rings. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. An end ring assembly for attachment to a cylindrical rotary printing screen, the end ring assembly comprising:
(a) an annular support ring adapted to be attached to an interior wall of the cylindrical rotary printing screen; and
(b) a drive ring adapted to be releasably attached to the annular support ring in position registration with the support ring to maintain alignment therewith upon rotation of the drive ring causing movement of the support ring and printing screen therewith during printing.

2. An end ring assembly according to claim 1, wherein the support ring comprises aluminum.

3. An end ring assembly according to claim 1, wherein the drive ring is releasably attached to the support ring by screws.

4. An end ring assembly according to claim 1, wherein the drive ring comprises a registration pin and the support ring is adapted to receive the registration pin.

5. An end ring assembly according to claim 1, wherein the drive ring comprises a cylindrical extension and the support ring has a cylindrical inner surface sized to receive the cylindrical extension.

6. An end ring assembly according to claim 1, wherein the support ring comprises a raised annular shoulder for abutting the drive ring.

7. A method of cleaning and/or storing a cylindrical rotary printing screen comprising:
(a) providing a cylindrical rotary printing screen having two longitudinal ends;
(b) providing an end ring assembly to each longitudinal end of the screen, each end ring assembly having an annular support ring attached to an interior wall of the cylindrical rotary printing screen and a drive ring releasably attached to the annular support ring in position registration with the support ring;
(c) removing the drive rings from the support rings; and
(d) cleaning and/or storing the cylindrical rotary printing screen with the support rings attached thereto.

8. A method according to claim 7, wherein the support ring comprises aluminum.

9. A method according to claim 7, wherein the drive ring is releasably attached to the support ring by screws.

10. A method according to claim 7, wherein the drive ring comprises a registration pin and the support ring is adapted to receive the registration pin.

11. An end ring assembly according to claim 7, wherein the drive ring comprises a cylindrical extension and the support ring has a cylindrical inner surface sized to receive the cylindrical extension.

12. An end ring assembly according to claim 7, wherein the support ring comprises a raised annular shoulder for abutting the drive ring.
